(19) United States
(12) Patent Application Publication
(10) Pub. No.: US 2016/0072531 A1
(43) Pub. Date: Mar. 10, 2016

(54) Methods and Systems for Support Vector Regression Based Non-Linear Interference Management in Multi-Technology Communication Devices

(71) Applicant: QUALCOMM Incorporated, San Diego, CA (US)

(72) Inventors: Farrokh ABRISHAMKAR, San Diego, CA (US); Alexandre Pierrot, San Diego, CA (US); Sheng-Yuan Tu, San Diego, CA (US)

(21) Appl. No.: 14/849,568

(22) Filed: Sep. 9, 2015

Related U.S. Application Data
(60) Provisional application No. 62/048,519, filed on Sep. 10, 2014.

(51) Int. Cl. H04B 1/10

(52) U.S. Cl. CPC H04B 1/1081; H04B 1/1036

(57) ABSTRACT

The various embodiments include methods and apparatuses for canceling nonlinear interference during concurrent communication of multi-technology wireless communication devices. Nonlinear interference may be estimated using a support vector regression interference filter by generating one or more aggressor kernels, augmenting the one or more kernels by weight factors, and executing a regression function of the augmented components, to produce an estimated jammer signals. At an output layer, estimated jammer signals may be linearly combined to produce an estimated nonlinear interference used to cancel the nonlinear interference of a victim signal.

### RELATED APPLICATIONS

This application claims the benefit of priority under 35 U.S.C. §119(e) of U.S. Provisional Application No. 62/048,519 entitled “Multilayer Perceptron For Dual SIM Dual Active Interference Cancellation” filed Sep. 10, 2014 the entire contents of which are hereby incorporated by reference.

### BACKGROUND

Some wireless communication devices—such as smart phones, tablet computers, laptop computers, and routers—contain hardware and/or software elements that provide access to multiple wireless communication networks simultaneously. For example, a wireless communication device can have one or more radio frequency communication circuits (or “RF chains”) for accessing one or more wireless local area networks (“WLANs”), wireless wide area networks (“WWANs”), and/or global positioning systems (“GPS”). When multiple reception (“Rx”) and/or transmission (“Tx”) operations are implemented simultaneously, i.e., co-exist, on a wireless communication device, these operations may interfere with each other.

### SUMMARY

The methods and multi-technology communication device of various embodiments provide circuits and methods for managing non-linear interference in multi-technology communications devices. Embodiment methods may include receiving an aggressor signal at the multi-technology communication device, generating one or more aggressor kernels from the aggressor signal, augmenting the one or more aggressor kernels with weight factors at a hidden layer of a support vector regression interference filter to obtain one or more augmented aggressor kernels, executing a first regression function on the one or more augmented aggressor kernels at the hidden layer to produce a real jammer signal estimate, and executing a second regression function on the one or more augmented aggressor kernels to produce an imaginary jammer signal estimate.

Some embodiments may include executing at an output layer, a linear combination on the real jammer signal estimate and imaginary jammer signal estimates to produce an estimated nonlinear interference. Such embodiments may further include cancelling the estimated nonlinear interference from a victim signal.

Some embodiments may include combining the real jammer signal estimate and imaginary jammer signal estimate to produce an estimated nonlinear interference, determining an error of the estimated nonlinear interference, determining whether the error of the estimated nonlinear interference exceeds an efficiency threshold, and cancelling the estimated nonlinear interference from a victim signal. In such embodiments, cancelling the estimated nonlinear interference from a victim signal may include cancelling the estimated nonlinear interference from the victim signal in response to determining that the error of the estimated nonlinear interference does not exceed the efficiency threshold. Such embodiments may further include training the weight factors to reduce the error of the estimated nonlinear interference in response to determining that the error of the estimated nonlinear interference exceeds the efficiency threshold. In such embodiments, training the weight factors to reduce the error of the estimated nonlinear interference may include executing a support vector regression algorithm on a set of actual received aggressor and victim signals to produce new weight factor values.

Some embodiments may include receiving one or more aggressor signals at the multi-technology communication device, and executing a support vector regression algorithm on the one or more aggressor signals to derive the first regression function, the second regression function, and weight factors.

In some embodiments, the kernel generator may include a Gaussian radial basis function.

In some embodiments, the one or more aggressor kernels may be non-linear inputs derived from the aggressor signal.

In some embodiments, the first regression function and the second regression function may be equivalent models, and may be associated with different weight factors.

Embodiments include a multi-technology communication device having one or more processors or processor cores configured with processor-executable instructions to perform operations of one or more of the embodiment methods described above.

Embodiments include a multi-technology communication device having means for performing functions of one or more of the embodiment methods described above.

Embodiments include a non-transitory processor-readable medium having stored thereon processor-executable software instructions configured to cause a processor of a multi-technology communication device to perform operations of one or more of the embodiment methods described above

### BRIEF DESCRIPTION OF THE DRAWINGS

The accompanying drawings, which are incorporated herein and constitute part of this specification, illustrate exemplary embodiments of the claims, and together with the general description given above and the detailed description given below, serve to explain the features of the claims.

FIG. 1 is a communication system block diagram illustrating a network suitable for use with various embodiments.

FIG. 2 is a component block diagram illustrating various embodiments of a multi-technology wireless communications device.

FIG. 3 is a component block diagram illustrating an interaction between components of different transmit/receive chains in various embodiments of a multi-technology wireless communications device.

FIGS. 4A-B are a component block diagram illustrating a nonlinear interference cancellation system in accordance with various embodiments.

FIG. 5 is a component block diagram illustrating a support vector machine based regression interference filter in accordance with various embodiments.

FIG. 6 is a functional block diagram illustrating an interaction between components of a support vector machine based regression interference filter with a kernel input in accordance with various embodiments.

FIG. 7 is a process flow diagram illustrating a method for canceling nonlinear interference using a support vector machine based regression interference filter in various embodiments of a multi-technology wireless communications device in accordance with various embodiments.

FIG. 8 is a process flow diagram illustrating a method for estimating nonlinear interference using a support vector machine based regression interference filter in a multi-technology wireless communications device in accordance with various embodiments.

FIG. 9 is a process flow diagram illustrating a method for training weight factors for use in a support vector machine based regression interference filter in a multi-technology wireless communications device in accordance with various embodiments.

FIG. 10 is a component diagram of an example multi-technology wireless communication device suitable for use with various embodiments.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

The word “exemplary” is used herein to mean “serving as an example, instance, or illustration.” Any implementation described herein as “exemplary” is not necessarily to be construed as preferred or advantageous over other implementations.

The terms “computing device,” “mobile device,” and “wireless communication device” are used interchangeably herein to refer to any one or all of cellular telephones, smartphones, personal or mobile multi-media players, personal data assistants (PDAs), laptop computers, tablet computers, smartbooks, ultrabooks, palm-top computers, wireless electronic mail receivers, multimedia Internet enabled cellular telephones, wireless gaming controllers, and similar personal electronic devices which include a memory, a programmable processor and wireless communication circuitry. As used herein, the terms “multi-technology communication device” and “multi-technology communication device” refer to a wireless communication device that supports access to at least two mobile communication networks. While the various embodiments are particularly useful for mobile devices, such as smartphones, the embodiments are generally useful in any electronic device that implements radio hardware in close proximity to other hardware.

Descriptions of the various embodiments refer to multi-technology communication devices for exemplary purposes. However, the embodiments may be suitable for any multiple-technology (multi-technology) wireless communication device that may individually maintain a plurality of connections to a plurality of mobile networks through one or more radio communication circuits. For example, the various embodiments may be implemented in multi-SIM multi-active devices of any combination of a number of subscriber identity modules (SIM) and concurrently active subscriptions. Moreover, a SIM may not be required for a wireless communication device to implement the various embodiments, which may apply to any form of wireless communications.

In a wireless communication device with multiple RF chains, the antennas of the RF chains may be in close proximity to each other. This close proximity may cause one RF chain to desensitize or interfere with the ability of another during the simultaneous use of the RF chains. Receiver desensitization (“desense”), or degradation of receiver sensitivity, may result from noise interference of a nearby transmitter. In particular, when two radios are close together with one transmitting on the uplink (the “aggressor”) and the other receiving on the downlink (the “victim”), signals from the transmitter may be picked up by the receiver or otherwise interfere with reception of a weaker signal (e.g., from a distant base station). As a result, the received signals may become corrupted and difficult or impossible for the victim to decode. In particular, desense of received signals presents a design and operational challenge for multi-radio devices due to the proximity of transmitter and receiver.

Multi-technology devices enable a user to connect to different mobile networks (or different accounts on the same network) while using the same multi-technology communication device. For example, a multi-technology communication device may connect to GSM, TDSCDMA, CDMA2000, WCDMA and other radio frequency networks. In the various embodiments, multi-technology communication devices may also include two RF chains so that each network communication supported by each RF chain can be accomplished concurrently.

However, multi-technology devices can suffer from interference between two communications being accomplished concurrently, such as when one communication session is transmitting (“Tx”) at the same time as another communication session is attempting to receive (“Rx”). As used herein, the term “victim” refers to the communication service or subscription suffering from interference at a given instant, and the term “aggressor” refers to the communication service or subscription whose Rx or Tx actions are causing the interference. In an example multi-technology communication device, the victim may be attempting to receive RF signals from a network while the aggressor attempts to transmit RF signals to another network. In an example of such interference, an aggressor's transmissions may desense the victim's reception, in which case the victim may receive the aggressor's transmissions that act as noise and interfere with the victim's ability to receive wanted RF signals.

In multi-technology communication devices, an aggressor's transmissions may cause severe impairment to the victim's ability to receive transmissions. This interference may be in the form of blocking interference, harmonics, intermodulation, or other noises and distortion. Such interference may significantly degrade the victim's receiver sensitivity, link to a network, voice call quality and data throughput. These effects may result in a reduced network capacity for the affected communication service or subscription. The aggressor's transmission may also cause receiver sensitivity of the victim signal that is drastically degraded, resulting in call quality degradation, higher rates for call drops and radio link failures, and data throughput degradation, which may potentially cause the victim to lose a data connection.

Nonlinear signals of the RF chains may be to blame for desense of received signals. Often the Tx/aggressor signal frequency is a fraction of the Rx/victim signal frequency. However, multiple aggressor signals may constructively combine to form a harmonic aggressor signal to the victim signal. The harmonic aggressor signal may be strong enough to cause nonlinear interference of the victim signal.

In order to recover information from the victim signal, various circuits and processing methods may be used to remove or subtract the interfering signals from the received victim signal. However, removing or subtracting nonlinear interference from a victim signal is particularly problematic for devices having multiple RF chains, such as multi-SIM multi-active (“MSMA”) devices and for Long-Term Evolution (“LTE”) carrier aggregation, because interference experienced on one RF chain may come from multiple RF sources and thus may have unpredictable signal form. Current techniques for removing nonlinear interference from a victim signal are case specific, requiring the communications device to have knowledge of the communication technology used for the transmission and reception of signals, and the kind of interference the aggressor signal is causing.

The various embodiments include methods for removing nonlinear interference from a victim signal in digital communications by using a support vector regression analysis method to estimate the coefficients of the signal to be removed before a received signal is decoded. In particular, the support vector regression interference filter may implement supervised learning using a regression analysis based on support vector machine implementations to dynamically estimate an interference of the aggressor signals on the victim signal to be removed from the victim signal so that it may be decoded. An absolute calculation of the nonlinear interference may be mathematically difficult. Accordingly, the various embodiments provide methods that may be implemented in cost effective circuits and processing algorithms to provide an effective estimate of the interference, which when subtracted from the victim signal results in significant improvement in the recovered signal.

In various embodiments, a mobile device may use the method to estimate a function of the nonlinear interference from a set of known aggressor reference signals and a victim reference signal without having to know the type of communication technology or type, source or form of interference. The set of aggressor reference signals may be obtained from the RF chain on the mobile device supporting the aggressor reference signals. The victim reference signal may be obtained from the RF chain on the mobile device supporting the victim reference signal. These known signals may be received by the support vector regression interference filter at an input layer. In various embodiments, the aggressor reference signal may be a complex signal that may be divided into one or more real and imaginary aggressor signals. In various embodiments, the aggressor reference signal may be used to generate a dominant kernel of aggressor signals, which may be divided into one or more real and imaginary aggressor kernels and received at the input layer in place of the aggressor reference signal. From the input layer the support vector regression interference filter may pass the aggressor reference signals to a hidden layer. In passing these signals to nodes of the hidden layer, the aggressor reference signals may be augmented using weight factors. The augmented aggressor reference signals may be used as inputs in the execution of a regression function. An output of the hidden layer may be passed to an output layer. All of the outputs of the hidden layer may again be linearly combined. An output of the output layer may be an estimation of a nonlinear interference that may be removed from a received victim signal.

In various embodiments, the regression function and weight factors used to estimate the function of the nonlinear interference may be trained using the victim reference signal and one or more aggressor signals, where a “reference” signal may be an actual signal from a previous time period and may include some current signals. Actual samples of the victim reference signals and one or more aggressor reference signals for recent time periods may be used to derive a regression function that defines a hyperplane dividing the victim and aggressor signals. Once the regression functions are derived, actual victim and aggressor signals for a current time may be passed to the regression function, which may effectively categorize the input and categorized as victim or noise. The estimated nonlinear interference may be used to calculate the error between the victim reference signal and the estimated victim signal. The trained weight factors and regression function may be updated in the support vector regression interference filter to increase the accuracy of the estimated nonlinear interference.

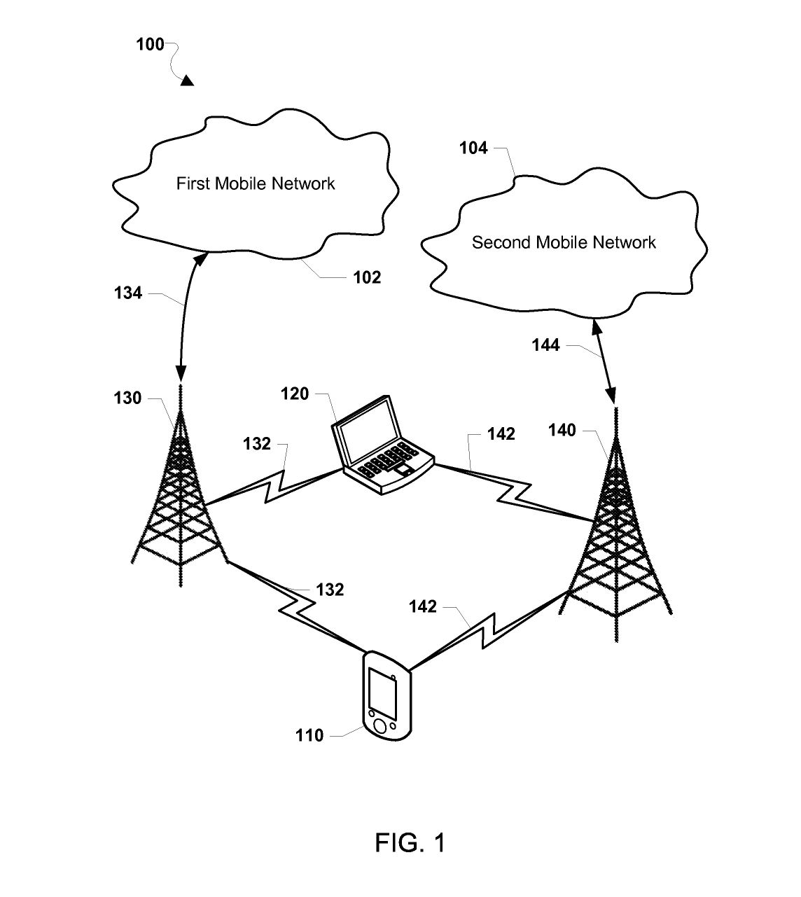

The various embodiments may be implemented in wireless communication devices that operate within a variety of communication systems 100, such as at least two mobile telephony networks, an example of which is illustrated in FIG. 1. A first mobile network 102 and a second mobile network 104 are typical mobile networks that include a plurality of cellular base stations 130 and 140. A first multi-technology communication device 110 may be in communication with the first mobile network 102 through a cellular connection 132 to a first base station 130. The first multi-technology communication device 110 may also be in communication with the second mobile network 104 through a cellular connection 142 to a second base station 140. The first base station 130 may be in communication with the first mobile network 102 over a connection 134. The second base station 140 may be in communication with the second mobile network 104 over a connection 144.

A second multi-technology communication device 120 may similarly communicate with the first mobile network 102 through a radio based communication connection such as a cellular connection 132 to a first base station 130. The second multi-technology communication device 120 may communicate with the second mobile network 104 through a radio communication connection such as a cellular connection 142 to the second base station 140. Cellular connections 132 and 142 may be made through two-way wireless communication links, such as 4G, 3G, CDMA, TDSCDMA, WCDMA, GSM, and other mobile telephony communication technologies. Other radio communication connections may include various other wireless connections, including WLANs, such as Wi-Fi based on IEEE 802.11 standards, and wireless location services, such as GPS. For example, the first wireless communications device may transmit and receive Wi-Fi communications from a network resource such as a router. Similarly, the wireless communications device may transmit and receive wireless communications with multiple Bluetooth enabled devices such as peripheral devices (e.g., keyboards, speakers, displays) as well as the second wireless communications device. The transmission and receipt of wireless communications over any and all of these radio resources may result in desense on victim signals during overlapping periods of transmissions.

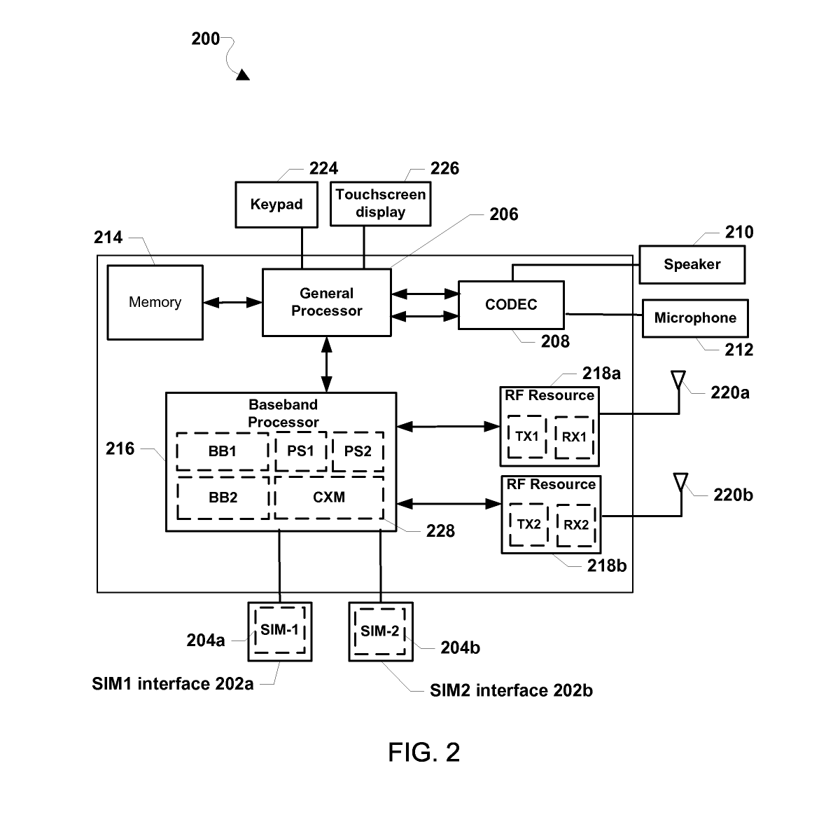

FIG. 2 illustrates various embodiments of a multi-technology communication device 200 (e.g., 110, 120 in FIG. 1) that are suitable for implementing the various embodiments. With reference to FIGS. 1 and 2, the multi-technology communication device 200 may include a first SIM interface 202a, which may receive a first identity module SIM-1 204a that is associated with a first subscription. The multi-technology communication device 200 may also include a second SIM interface 202b, which may receive a second identity module SIM-2 204b that is associated with second subscription.

A SIM in the various embodiments may be a Universal Integrated Circuit Card (UICC) that is configured with SIM and/or USIM applications, enabling access to, for example, GSM and/or UMTS networks. The UICC may also provide storage for a phone book and other applications. Alternatively, in a CDMA network, a SIM may be a UICC removable user identity module (R-UIM) or a CDMA subscriber identity module (CSIM) on a card.

Each SIM may have a CPU, ROM, RAM, EEPROM and I/O circuits. A SIM used in the various embodiments may contain user account information, an international mobile subscriber identity (IMSI), a set of SIM application toolkit (SAT) commands and storage space for phone book contacts. A SIM may further store a Home Public-Land-Mobile-Network (HPLMN) code to indicate the SIM card network operator provider. An Integrated Circuit Card Identity (ICCID) SIM serial number may be printed on the SIM for identification.

Each multi-technology communication device 200 may include at least one controller, such as a general purpose processor 206, which may be coupled to a coder/decoder (CODEC) 208. The CODEC 208 may in turn be coupled to a speaker 210 and a microphone 212. The general purpose processor 206 may also be coupled to at least one memory 214. The memory 214 may be a non-transitory tangible computer readable storage medium that stores processor-executable instructions. For example, the instructions may include routing communication data relating to the first or second subscription though a corresponding baseband-RF resource chain.

The memory 214 may store operating system (OS), as well as user application software and executable instructions. The memory 214 may also store application data, such as an array data structure.

The general purpose processor 206 and memory 214 may each be coupled to at least one baseband modem processor 216. Each SIM in the multi-technology communication device 200 (e.g., SIM-1 202a and SIM-2 202b) may be associated with a baseband-RF resource chain. Each baseband-RF resource chain may include the baseband modem processor 216 to perform baseband/modem functions for communications on a SIM, and one or more amplifiers and radios, referred to generally herein as RF resources 218a, 218b. In some embodiments, baseband-RF resource chains may interact with a shared baseband modem processor 216 (i.e., a single device that performs baseband/modem functions for all SIMs on the wireless device). Alternatively, each baseband-RF resource chain may include physically or logically separate baseband processors (e.g., BB1, BB2).

In some embodiments, the baseband modem processor 216 may be an integrated chip capable of managing the protocol stacks of each of the SIMs or subscriptions (e.g., PS1, PS2) and implementing a co-existence manager software 228 (e.g., CXM). By implementing modem software, subscription protocol stacks, and the co-existence manager software 228 on this integrated baseband modem processor 216, thread based instructions may be used on the integrated baseband modem processor 216 to communicate instructions between the software implementing the interference prediction, the mitigation techniques for co-existence issues, and the Rx and Tx operations.

The RF resources 218a, 218b may be communication circuits or transceivers that perform transmit/receive functions for the associated SIM of the wireless device. The RF resources 218a, 218b may be communication circuits that include separate transmit and receive circuitry, or may include a transceiver that combines transmitter and receiver functions. The RF resources 218a, 218b may be coupled to a wireless antenna (e.g., a first wireless antenna 220a and a second wireless antenna 220b). The RF resources 218a, 218b may also be coupled to the baseband modem processor 216.

In some embodiments, the general purpose processor 206, memory 214, baseband processor(s) 216, and RF resources 218a, 218b may be included in the multi-technology communication device 200 as a system-on-chip. In other embodiments, the first and second SIMs 202a, 202b and their corresponding interfaces 204a, 204b may be external to the system-on-chip. Further, various input and output devices may be coupled to components on the system-on-chip, such as interfaces or controllers. Example user input components suitable for use in the multi-technology communication device 200 may include, but are not limited to, a keypad 224 and a touchscreen display 226.

In some embodiments, the keypad 224, touchscreen display 226, microphone 212, or a combination thereof, may perform the function of receiving the request to initiate an outgoing call. For example, the touchscreen display 226 may receive a selection of a contact from a contact list or receive a telephone number. In another example, either or both of the touchscreen display 226 and microphone 212 may perform the function of receiving a request to initiate an outgoing call. For example, the touchscreen display 226 may receive a selection of a contact from a contact list or receive a telephone number. As another example, the request to initiate the outgoing call may be in the form of a voice command received via the microphone 212. Interfaces may be provided between the various software modules and functions in multi-technology communication device 200 to enable communication between them, as is known in the art.

In some embodiments, the multi-technology communication device 200 may instead be a single-technology or multiple-technology device having more or less than two RF chains. Further, various embodiments may implement, single RF chain or multiple RF chain wireless communication devices with fewer SIM cards than the number of RF chains, including without using any SIM card.

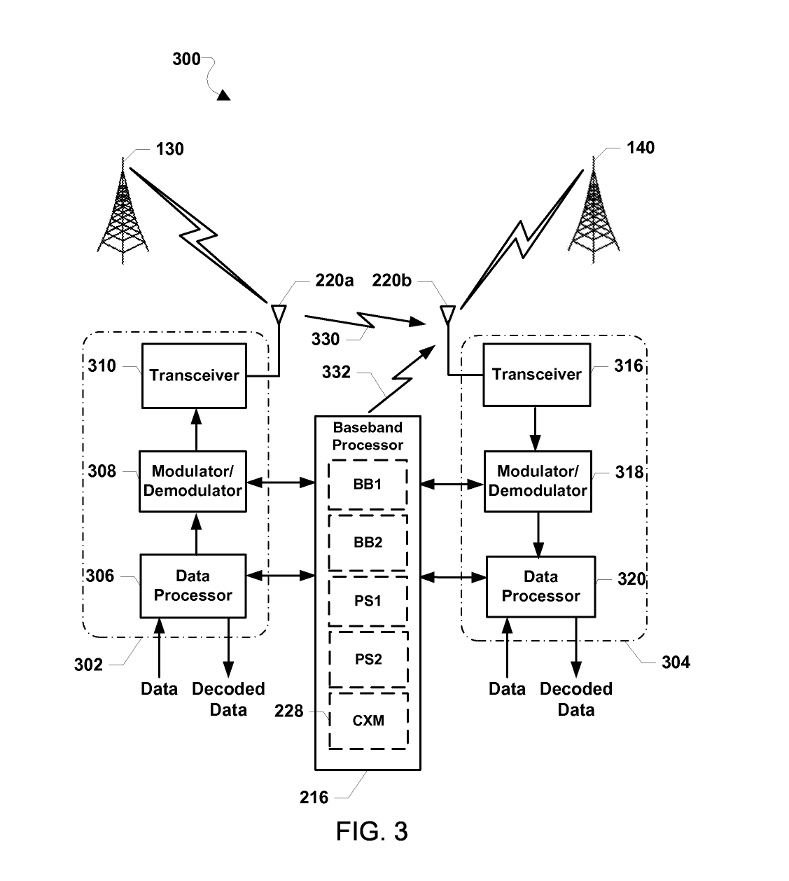

FIG. 3 is a block diagram of a communication system 300 that illustrates embodiment interactions between components of different transmit/receive chains in a multi-technology wireless communications device. With reference to FIGS. 1-3, for example, a first radio technology RF chain 302 may be one RF resource 218a, and a second radio technology RF chain 304 may be part of another RF resource 218b. In some embodiments, the first and second radio technology RF chains 302, 304 may include components operable for transmitting data. When transmitting data, a data processor 306, 320 may format, encode, and interleave data in preparation for transmission. A modulator/demodulator 308, 318 may modulate a carrier signal with encoded data, for example, by performing Gaussian minimum shift keying (GMSK). One or more transceiver circuits 310, 316 may condition the modulated signal (e.g., by filtering, amplifying, and up-converting) to generate an RF modulated signal for transmission. The RF modulated signal may be transmitted, for example, to the base station 130, 140 via an antenna, such as the antenna 220a, 220b.

The components of the first and second radio technology RF chains 302, 304 may also be operable to receive data. When receiving data, the antenna 220a, 220b may receive RF modulated signals from the base station 130, 140 for example. The one or more transceiver circuits 310, 316 may condition (e.g., filter, amplify, and down-convert) the received RF modulated signal, digitize the conditioned signal, and provide samples to the modulator/demodulator 308, 318. The modulator/demodulator 308, 318 may extract the original information-bearing signal from the modulated carrier wave, and may provide the demodulated signal to the data processor 306, 320. The data processor 306, 320 may de-interleave and decode the signal to obtain the original, decoded data, and may provide decoded data to other components in the wireless device.

Operations of the first and second radio technology RF chains 302, 304 may be controlled by a processor, such as the baseband processor(s) 216. In the various embodiments, each of the first and second radio technology RF chains 302, 304 may be implemented as circuitry that may be separated into respective receive and transmit circuits (not shown). Alternatively, the first and second radio technology RF chains 302, 304 may combine receive and transmit circuitry (e.g., as transceivers associated with SIM-1 and SIM-2 in FIG. 2).

As described, interference between the first and second radio technology RF chains 302, 304, such as de-sense and interpolation, may cause the desired signals to become corrupted and difficult or impossible to decode. For example, a transmission signal 330 sent by the first radio technology RF chain 302 may be errantly received by the second radio technology RF chain 304. In addition, electronic noise 332 from circuitry, such as the baseband processor 216, may also contribute to interference on the first and second radio technology RF chains 302, 304. To avoid such interference, the multi-technology communication device may implement various embodiment algorithms to estimate a nonlinear interference caused by the transmissions signal 330 and cancel the estimated nonlinear interference from victim signals received by the second radio technology RF chain 304.

For the purpose of providing a clear disclosure, signals received by a wireless communications device will be referred to as victim signals. However, victim signals may also be transmission signals experiencing desense caused by incoming received signals.

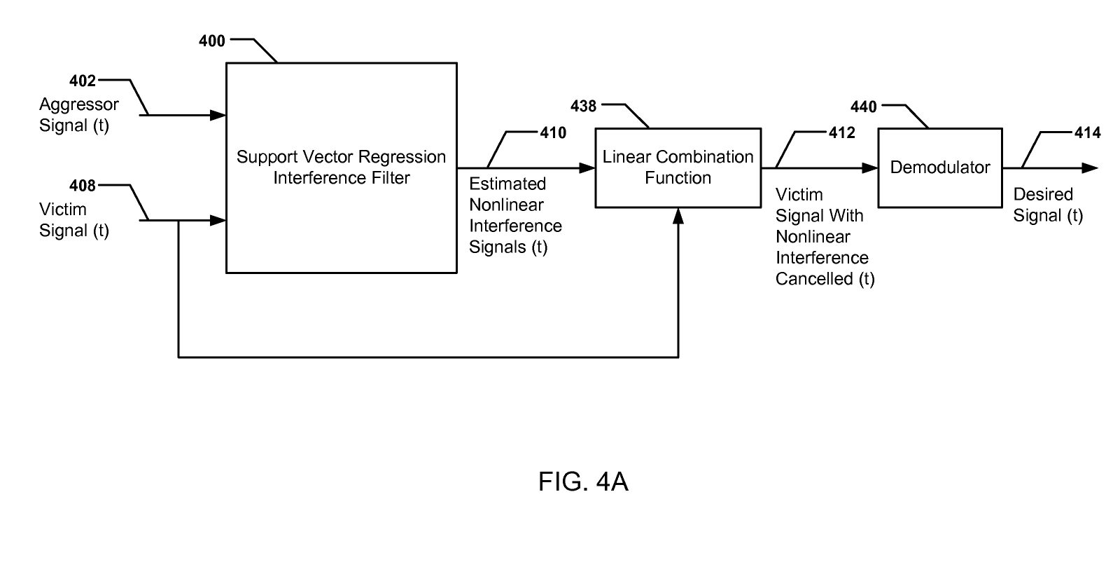

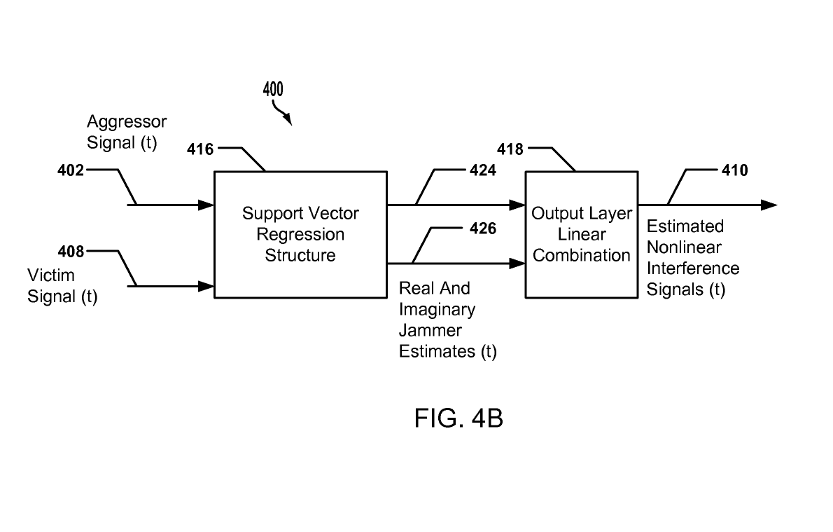

The various embodiments provide efficient algorithms that may be implemented in circuitry, in software, and in combinations of circuitry and software for estimating the nonlinear interference present in a victim signal without requiring a complete understanding or rigorous mathematical model of the aggressor signal or sources of the nonlinear interference. The embodiment algorithms are premised upon a general mathematical model of the nonlinear interferences, which for completeness is described below with reference to equations 1-3. These equations are not necessarily directly solvable, and provide a model for structuring that nonlinear interference cancellation system according to various embodiments described below beginning with FIG. 4A.

In this mathematical model, the actual nonlinear interference signal is modeled as the interference experienced by a victim signal as a result of one or more aggressor signal(s) z(t). In this model, the actual nonlinear interference signal L(t) caused by one or more hypothetical aggressor signal(s) z(t) on a hypothetical victim signal at a time “t” may be represented by the function:

L(t)=\sqrt{JNR}·J(z(t)) [Eq. 1]

where JNR is a jammer to noise ratio (a value that could be measured at time t) and J(z(t)) is a Jacobean matrix of all hypothetical aggressor signals z(t). JNR is a value that can be calculated based on measurements but is not required in the embodiment algorithms.

Similarly, the estimated nonlinear interference signal \hat{L}(t) for a time “t” may be expressed as:

\hat{L}(t)=\sqrt{JNR}·ĵ(z(t)) [Eq. 2]

where JNR is again the jammer to noise ratio and Ĵ(z(t)) is a jacobian matrix of all aggressor signals z(t) (discussed in detail with reference to FIGS. 4B-6 below). The estimated function \hat{L}(t) is an estimate of the actual nonlinear interference signal L(t) as discussed above. This estimated nonlinear interference signal \hat{L}(t) may be the result of manipulation of the aggressor signal z(t) by the support vector regression interference filter according to various embodiments as described below.

A victim signal y(t) may be the signal actually received by the multi-technology wireless communications device and may be degraded as a result of interference from the one or more aggressor signals z(t). The victim signal y(t) for the time “t” received by the multi-technology wireless communications device may be represented as the function:

y(t)={square root over (SNR·x(t)+J(z(t−τ)))}+v(i) [Eq. 3]

where elements of the victim signal y(t) may be expressed in terms of the signal-to-noise ratio (SNR), the intended receive signal represented as a function x(t), the jammer-to-noise ratio (JNR) of equation 2, the Jacobian matrix of all aggressor signals z(t−τ) for a time “t”, and a noise in the victim signal, such as thermal noise an inter-device interference, represented by the function v(i). As with equations 1 and 2 above, the victim signal in equation 3 is provided as a mathematical representation illustrating the relationship between the various signals.

Theoretically, the intended received signal x(t) may be obtained by rearranging the terms in Equation 3 to solve for x(t). A direct solution of these model equations may not be feasible in real time, particularly within mobile communication devices that have limited processing power. Therefore, the various embodiments employ a support vector regression interference filter to generate an estimate of the nonlinear interference signal L(t) without directly solving equations 1-3.

FIG. 4A illustrates a nonlinear interference cancellation system including a support vector regression interference filter 400 that may be used to remove an estimate of the nonlinear interference from a victim signal in accordance with various embodiments. With reference to FIGS. 1-4A support vector regression interference filter 400 may be implemented in a multi-technology wireless communications device (e.g., 110, 120, 200 in FIGS. 1 and 2) in software, general processing hardware, dedicated hardware, or a combination of any of the preceding. The support vector regression interference filter 400 may be configured to receive an aggressor signal 402 and a victim signal 408 at a time “t”. The support vector regression interference filter 400 may be configured to produce an estimated nonlinear interference signal 410 for the time “t”.

In some embodiments, the support vector regression interference filter 400 may be a support vector regression technique (shown in FIG. 4B) implemented in a multi-technology wireless communications device (shown in FIG. 4B as support vector regression structure 416). For any time “t”, the support vector regression interference filter 400 may be implemented to help identify an intended receive signal x(t), the signal the communications device would have received but for experienced interference, from among the elements of the actually received victim signal 408. Given an aggressor signal 402, the support vector regression interference filter 400 may implement support vector machine learning algorithms to produce an estimated nonlinear interference signal 410 for time “t” that may be cancelled from the victim signal 408.

The estimated nonlinear interference signal 410 for the time “t” may be used by a linear combination function 438 to cancel the estimated nonlinear interference signal 410 from the victim signal 408. For example, the linear combination function 438 may subtract, add, or otherwise mathematically manipulate portions of the estimated nonlinear interference signal 410 affecting the victim signal 408. Thus, unnecessary elements of the victim signal 408 caused by aggressor signal 402 interference may be removed from the victim signal 402 and elements obscured by aggressor signal 402 interference may be recaptured. The result of the linear combination function 438 may be the victim signal with the nonlinear interference cancelled 412. A demodulator 440 may receive the victim signal with the nonlinear interference cancelled 412 and demodulate it to produce the desired signal 414.

In various embodiments, the support vector regression interference filter 400 may include computer implementations of support vector regression machine learning algorithms. One or more aggressor signals 402 may be provided as input to the support vector regression interference filter 400 as will be discussed in greater detail with reference to FIGS. 4B-6B below. The aggressor signal input(s) 402 may be manipulated by the support vector regression interference filter 400 in a series of mathematical operations and estimations to generate the estimated nonlinear interference signal 410. Because of the mathematical complexity associated with calculation of an actual nonlinear interference signal, perceptron machine learning algorithms and linear filter functions (e.g., Hammerstein structure) may be implemented to produce an estimate of an experienced nonlinear interference signal such as the estimated nonlinear interference signal 410. As such, the various formulas described herein are mathematical representations of actual and estimated signals that are utilized or produced by the support vector regression interference filter 400. These mathematical representations may not be actively calculated by the support vector regression interference filter 400, but are provided to enable one of ordinary skill in the art to realize the relationships between elements of the various signals as they are manipulated by the operations described herein.

As discussed with reference to equations 1 and 2 above, the estimated nonlinear interference signal 410 may be described in terms of one or more aggressor signals 402. Thus, the production of the estimated nonlinear interference signal 410 may depend on the manipulation of the aggressor signals 402 by the support vector regression interference filter 400. In some embodiments, the support vector regression interference filter 400 may accept the result of a kernel function executed on the aggressor signal 402 (i.e., aggressor kernel(s)). These embodiments will be discussed in greater detail with reference to FIG. 4B below.

Generating the estimated nonlinear interference signal 410 for the time “t” may be accomplished by the support vector regression interference filter 400 in a blind and universal manner. In other words, the support vector regression interference filter 400 may estimate the estimated nonlinear interference signal 410 without knowing some information about the radio access technology used by the multi-technology wireless communications device and/or the kind of interference occurring on the victim signal 408.

FIG. 4B illustrates components of a support vector regression interference filter 400 of a nonlinear interference cancellation system that may be used to remove an estimate of the nonlinear interference from a victim signal 408 in accordance with various embodiments. With reference to FIGS. 1-4B a support vector regression interference filter 400 may be implemented in a multi-technology wireless communications device (e.g., 110, 120, 200 in FIGS. 1 and 2) in software, general processing hardware, dedicated hardware, or a combination of any of the preceding. The support vector regression interference filter 400 may be configured to receive an aggressor signal 402 and victim signal 408 and perform a series of mathematical manipulations to produce one or more estimated nonlinear interference signals 410.

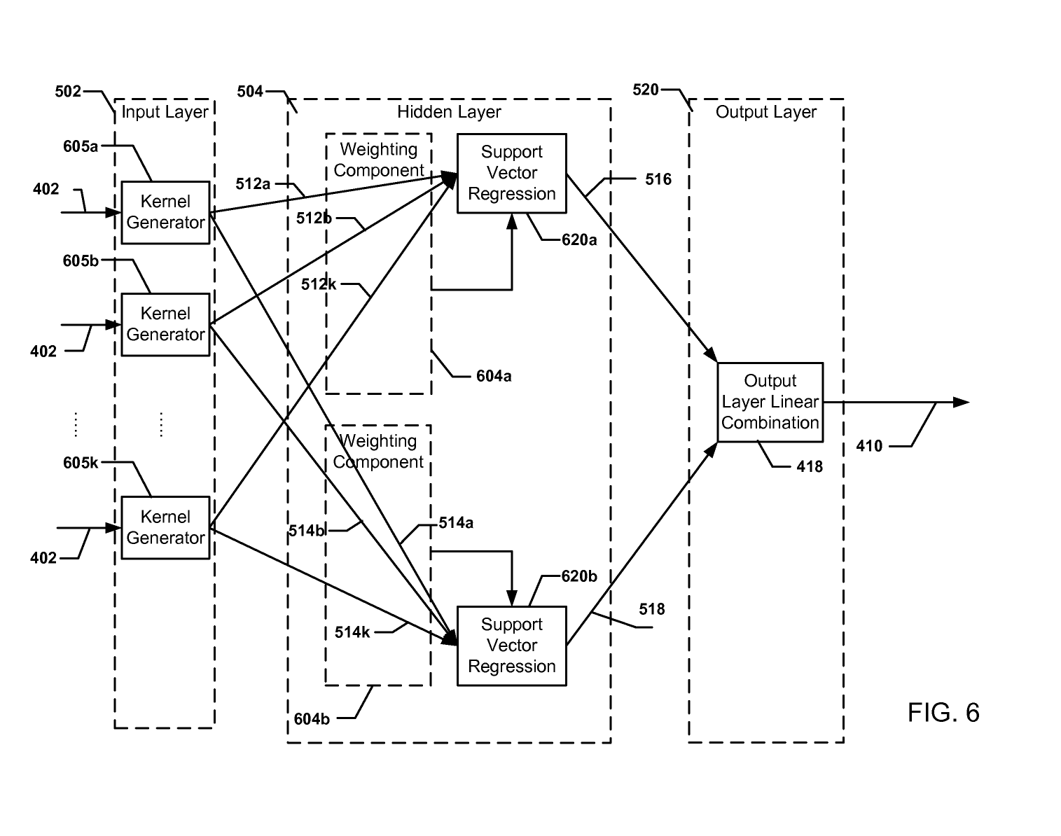

In various embodiments, the input may include the aggressor signal 402. The support vector regression structure may also receive a victim signal 408 for use in deriving a regression function that the support vector regression structure may apply to the aggressor signal 402. The input may be received at support vector regression structure 416 of the support vector regression interference filter 400. As discussed further with reference to FIG. 6, the support vector regression structure 416 may produce a complex jammer signal estimate (including estimates 424 and 426). The complex jammer signal estimate may include a real jammer signal estimate component 424 and an imaginary jammer signal estimate component 426. In some embodiments, the estimated jammer components 424, 426 may be combined at an output layer linear combination 418 to produce an estimated nonlinear interference 410. In other embodiments, the complex estimated nonlinear interference may include an estimated real nonlinear interference component and an estimated imaginary nonlinear interference signal component. These real and imagery components of the estimated nonlinear interference signal may be combined by a linear combination during the cancellation of interference from the victim signal 408.

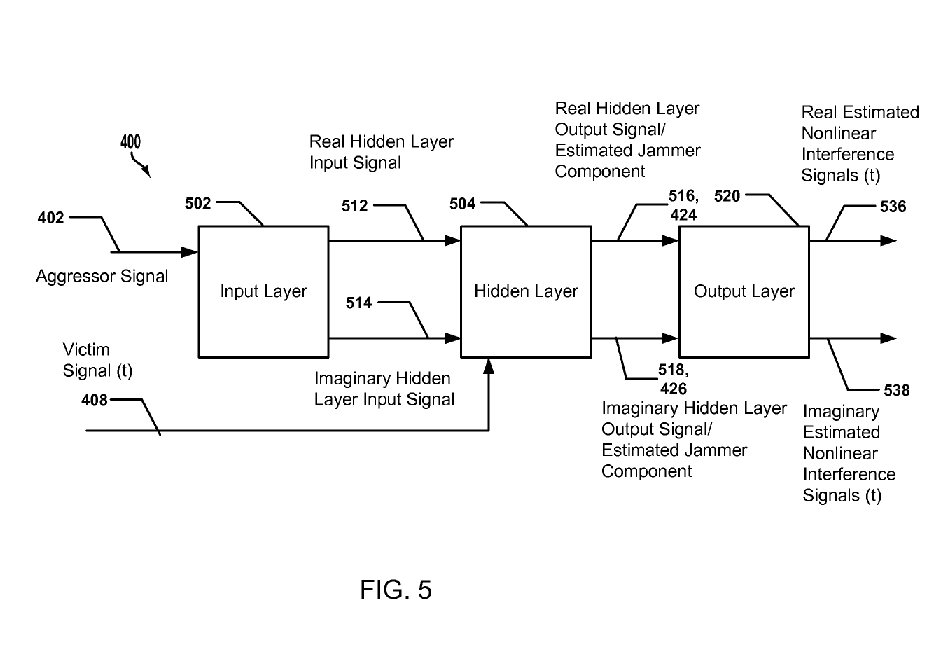

FIG. 5 illustrates implementation components of a support vector regression interference filter 400, which may be one or more layers of the support vector regression interference filter (e.g., 400 in FIG. 4) in accordance with various embodiments. With reference to FIGS. 1-5, the support vector regression interference filter 400 may include an input layer 502, a hidden layer 504, and an output layer 520, which may further the calculation of the estimated nonlinear interference signal 410 for time “t”. The hidden layer 504 may be configured to receive the victim signal 408 for use in deriving a regression function and training weight factors. The hidden layer 504 may be configured to receive a hidden layer input 512, 514 (i.e. one or more aggressor kernels). Hidden layer inputs may be generated from the aggressor signal 402. The hidden layer input 512, 514 may be the result of a kernel function applied to all or a portion of the aggressor signal 402. One or more kernel functions may be applied to the aggressor signal 402 in the input layer 502. In some embodiments, the support vector regression interference filter 400 may be configured to utilize the hidden layer input 512 to produce real and imaginary hidden layer output signals 516, 518. The hidden layer output signals 516, 518 may be the estimated jammer components 424, 426 at the time “t”.

In various embodiments, the hidden layer input 512, 514 may include one or more aggressor kernels generated from the aggressor signal 402 and one or more training sample aggressor signals (i.e. aggressor reference signals). The aggressor signal 402 may be represented as a function z(t) for the time “t”. The kernel generator function may be one of various kernel functions K(z(t)) such as an exponential (e.g., Gaussian radial basis function) or polynomial expansion of order “r”, for example \vec{z}^{r}(t). The kernel function may be applied to both the current aggressor signal and a training sample aggressor signal (e.g., z). For example a radial basis function kernel may be represented by the function:

K(z_{Train}(i),z(t))=exp(−γ∥z_{Train}(i)−z(t)∥₂²) [Eq. 4]

where z_{Train} (i) is a training aggressor signal from set “i”, z(t) is an aggressor signal for the time “t”, and γ is a dynamic parameter that may initially be fixed to 0.5 and may be redetermined during training phases. Thus, the aggressor kernel \hat{z}(t) may be represented by:

\hat{z}(t)=K(z_{Train}(i),z(t)) [Eq. 5]

where z_{Train}(t) is a training aggressor signal for a time “t”, z(t) is an aggressor signal for the time “t”, and K(t) is a kernel function.

The generated kernels may be passed as hidden layer input 512, 514 to a hidden layer 504. The hidden layer input signals 512, 514 may be used to produce the real hidden layer output signal 516 and the imaginary hidden layer output signal 518. In the hidden layer, the hidden layer input signals (e.g. real and imaginary aggressor kernels) may be input into the hidden layer for support vector regression functions. The support vector functions may execute the regression function derived from the victim signal 408 and the one or more input aggressor kernels 512 (e.g., the aggressor signal and one or more training sample or reference aggressor signals). The result of the regression function may indicate whether the applicable portion of the aggressor signal 402 is noise that interferes with the victim signal 408. The application of support vector machine learning techniques to the hidden layer input signals 512, 514 may be the hidden layer output signals 516, 518 (i.e. the real and imaginary jammer signal estimates 424, 426).

Each support vector regression function of the hidden layer may receive a hidden layer input signals 512, 514. As discussed further with reference to FIG. 6, the hidden layer input signals 512, 514 may be the kernels generated at the input layer 502. The hidden layer 504 may receive the hidden layer input signals 512, 514, augment them with one or more weight factors, and/or execute a regression function (e.g., function derived using support vector regression) on the hidden layer inputs 512, 514 to produce a real hidden layer output signal 516 and an imaginary hidden layer output signal 518.

In various embodiments, one or more weight factors may augment the hidden layer input 512, 514. The augmentation of the hidden layer inputs 512, 514 may be represented as a summation of weight factors “α” and “α⁺” for a number of training sample aggressor signals “N.” The value of weights used to augment the hidden layer input 512, 514 may be determined during support vector regression node training on the victim signal 408, the aggressor signal 402, and one or more training sample aggressor signals (i.e., reference aggressor signals). In some embodiments, there may be a first set of one or more weight factors associated with a real regression function and a second set of one or more weight factors associated with an imaginary regression function. During support vector regression node training the values of “α” and “α⁺” may be derived using a training set of actual victim and aggressor reference signals. The number of training sample aggressor signals used in active interference cancellation may be determined by a required optimization granularity and may be adjusted as desired.

At each regression function, a regression function derived during support vector regression training may be executed on the hidden layer inputs 512, 514. In an embodiment the hidden layer may augment each element of hidden layer input 512, 514 with a summation of the one or more weight factors. The result may be linearly combined at the output layer 520 with a constant “b,” to generate real and imaginary estimated nonlinear interference signals 536 and 538.

The output layer 520 may receive the real hidden layer output signal 516 and the imaginary hidden layer output signal 518, and combine them to produce the estimated nonlinear interference signal 410. In some embodiments, the output layer may not combine the real hidden layer output signal 516 and the imaginary hidden layer output signal 518, but may instead pass them on to a linear combination as an estimated real nonlinear interference component 536 and an estimated imaginary nonlinear interference component 538 for combination and cancellation from the victim signal 408.

The real and imaginary estimated nonlinear interference \hat{L}_{Real} (z(i)), and \hat{L}_{Imag.}(z(t)) may be represented by the expressions:

\hat{L}_{Real}(z(i))=Σᵢ₌₁^{N}(α_{Real,i}+α_{Real,i}⁺)K(z_{Train}(i),z₁(i))+b_{Real} [Eq. 6]

\hat{L}_{Imag.}(z(i))=Σᵢ₌₁^{N}(α_{Imag.,i}+α_{Imag.,i}⁺)K(z_{Train}(i),z₁(i))+b_{Imag.} [Eq. 7]

where \hat{L}_{Real}(z(t)) is the real component of the estimated nonlinear interference signal, z(t) is an aggressor signal for a time “t”, N is a number of signal samples, α_{Real,i} is a set of real weight factors, K(z_{Train}(i), z₁(t)) is a kernel function, b_{Real} is a scalar constant associated with real component, \hat{L}_{Imag.}(z(t)) is the imaginary component of the estimated nonlinear interference signal, α_{Imag,i} is a set of imaginary weight factors, and b_{Imag.} is a scalar constant associated with imaginary components.

FIG. 6 illustrates interactions between components of a support vector regression interference filter (e.g., 400 in FIG. 4A) with an input (e.g., 402 in FIG. 4) in accordance with various embodiments. With reference to FIGS. 1-6, the support vector regression interference filter 400 may include an input layer 502, a hidden layer 504, and an output layer 520.

The input layer 502 may receive the aggressor signals 402, generate aggressor kernel components, and pass the aggressor kernel components as hidden layer inputs 512a-k, 514a-k to the hidden layer 504. The aggressor signals 402 may be passed to the kernel generators 605a-k. Each of the kernel generators 605a-k may apply a kernel function (e.g., a radial basis function, polynomial function, etc.) to the aggressor signals 402 to produce hidden layer inputs 512a-k, 514a-k. Each kernel generator may produce a real aggressor kernel component, i.e. real hidden layer input 512a-k. Similarly, each kernel generator may also generate an imaginary aggressor kernel component, i.e. imaginary hidden layer input 514a-k. These aggressor kernel components may be passed to each support vector regression function 620a, 620b of the hidden layer 504.

The hidden layer input 512a-k, 514a-k may be augmented by a weighting components 604a, 604b. The weighting components 604a, 604b may augment the hidden layer input 512a-k, 514a-k with one or more weight factors. The weighting components 604a, 604b may be incorporated into the calculation of the regression function by the support vector regression function 620a, 620b.

In various embodiments, each support vector regression function 620a, 620b may use the hidden layer inputs (i.e. aggressor kernel components) and support vector regression techniques to produce a regression function. The weighting components 604a, 604b may apply a set of predetermined initial one or more weight factors to the hidden layer input 512a-k, 514a-k. The initial one or more weight factors may be configured to reduce the error in the nonlinear regression function estimation. The initial weight factors (e.g. “a”) may be derived using a training sample of actual reference signals. In some embodiments, the one or more weight factors may be re-generated based on historical performance of previous weight factors to reduce the error in the nonlinear regression function estimation. As will be discussed in further detail, the support vector regression interference filter may derive new weight factors to improve the nonlinear interference signal estimation.

During the derivation of the regression function, the support vector regression interference filter may also derive the one or more weight factors (e.g. “a⁺”). The hidden layer inputs 512a-k, 514a-k may be augmented with the one or more weight factors by the weighting components 604a, 604b. The newly augmented hidden layer inputs 512a-k, 514a-k may be passed to the support vector regression functions 620a, 620b for further processing. In some embodiments, all real hidden layer inputs may be augmented by weighting component 604a and passed to support vector regression function 620a. Similarly, all imaginary hidden layer input 514a-k may be augmented by weighting component 604b and passed to support vector regression function 620b.

The support vector regression function 620a, 620b may execute the derived regression function on the augmented hidden layer input 512a-k, 514a-k. In various embodiments, one support vector regression function 620a may produce a real output component. Support vector regression function 620b may produce an imaginary output component. Some embodiments may include support vector regression functions 620a, 620b having equivalent support vector regression models, but different initial weight factors. The support vector regression functions 620a, 620b, may execute the regression function on the augmented hidden layer input using the one or more weight factors to produce a real hidden layer output signal 516 and an imaginary hidden layer output signal 518.

Hidden layer output signals 516, 518 may be passed to an output layer 520. The output layer 520 may include an output layer linear combination component 418 that may combine the real hidden layer output signal 516 and the imaginary hidden layer output signal 518 to produce an estimated nonlinear interference 410. The estimated nonlinear interference 410 may be removed from the victim signal 408.

In some embodiments, the output layer 520 may receive the real hidden layer output signal 516 and imaginary hidden layer output signal 518, and pass the signals along as real and imaginary components of the estimated nonlinear interference. The estimated real nonlinear interference component and the estimated imaginary nonlinear interference component may be combined to obtain an estimated non-linear interference signal 410. In some embodiments, the real estimated nonlinear interference may be cancelled from a real component of the received signal y(t) and the imaginary estimated nonlinear interference component may be cancelled from an imaginary component of the received signal y(t). The resulting real and imaginary components may then be combined to obtain the desired signal 414.

The estimated nonlinear interference signal 410 may be used for multiple purposes by a multi-technology communications device. In some embodiments, the estimated nonlinear interference signal 410 may be cancelled or subtracted from the victim signal 408 so that the victim signal 408 may be decoded and understood by the multi-technology communications device. In some embodiments, the estimated nonlinear interference signal 410 may be used to determine an error level. The error level in estimating the nonlinear interference on the victim signal 408 may be determined by a function comparing the estimated nonlinear interference signal 410 with a measured interference of the victim signal 408. The error may be calculated for any of the weight factors and “N” pairs of reference signals.

In some embodiments, the error of the estimated nonlinear interference signal 410 may be compared to an error threshold to determine whether the error is acceptable. Determining that the error present in an estimation of the nonlinear interference signal is unacceptable may prompt the support vector regression interference filter to train or retrain the weight factors to reduce the error in the estimated nonlinear interference signal 410. Training of the weight factors may be regressively executed to further reduce the error of the estimated nonlinear interference signal 410. In some embodiments, satisfactory weight factors may be reused for subsequent nonlinear interference estimations. The reuse of previously determined weight factors may be based on one or more parameters, such as time since the last adjustment of the weight factors and how the error in the estimated nonlinear interference signal 410 compares to the error threshold, and the like.

In the various examples, components of the support vector regression interference filter are shown individually or in combination. It should be understood that these examples are not limiting and the various other configurations of the components are considered. For example, the support vector regression functions, 620a, 620b and their components are illustrated as separate components. However, any of the support vector regression functions 620a, 620b and/or components may be embodied in combination with other components, and multiples of the same component may be embodied in a single component.

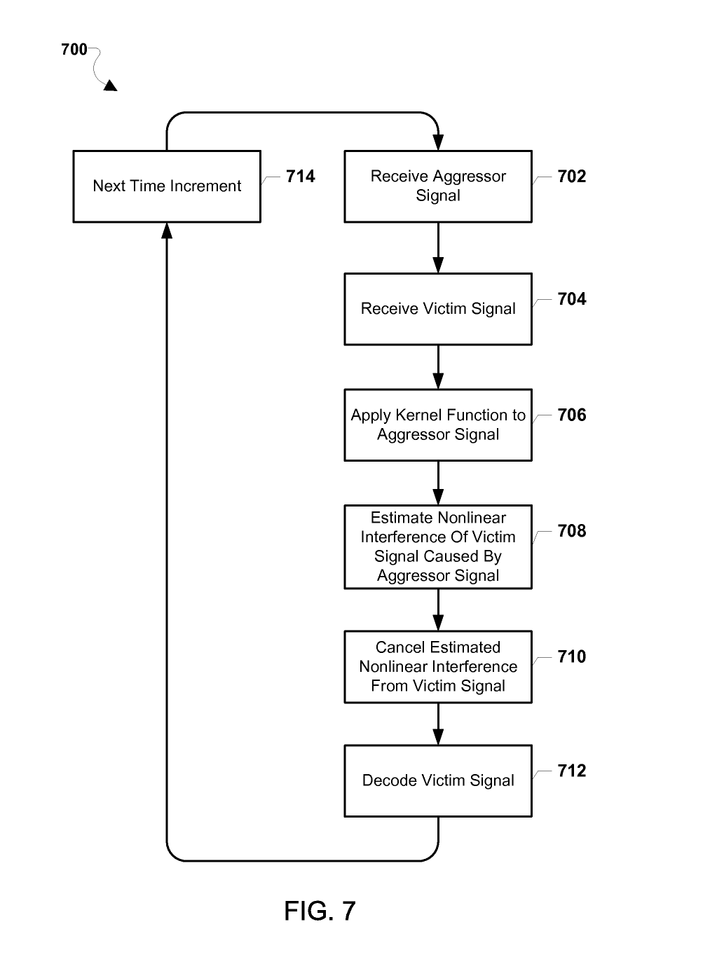

FIG. 7 illustrates a method 700 for canceling nonlinear interference from a received signal using a support vector regression interference filter (e.g., 400 in FIG. 4A) in a multi-technology wireless communications device in accordance with various embodiments. With reference to FIGS. 1-7, the method 700 may be executed in a computing device (e.g., 110, 120, 200) using software, general purpose or dedicated hardware, or a combination of software and hardware, such as the general purpose processor 206, baseband processor 216, or the like. In block 702, the multi-technology communication device may receive an aggressor signal. The aggressor signal may be received by a first radio access technology of the multi-technology communication device from a transmission of a second radio access technology of the same multi-technology communication device.

In block 704, the multi-technology communication device may receive a victim signal. The victim signal may be received by the first radio access technology of the multi-technology communication device from a transmitting source device separate from the multi-technology communication device. The victim signal may initially be unaffected by interference when transmitted from the transmitting source device. However, the victim signal may experience interference caused by the aggressor signal during transmission to the multi-technology communication device.

In optional block 706, the multi-technology communication device may generate a t aggressor kernel from the aggressor signal. The aggressor kernel may include a real component and an imaginary component. The aggressor signal received by the first radio access technology of the multi-technology communication device may be separated into a real component and an imaginary component. These components may be passed as inputs to a kernel function such as a harmonic or exponential function (e.g., a harmonic expansion), where the order of the kernel function may be dictated by information known about the transmission technology of the aggressor or victim signal. Alternatively, the entire aggressor signal may be passed to the kernel generator and the resulting kernel separated into a real component and an imaginary component. In either embodiment, the result of kernel function execution may be two N-element vectors having elements from “N” samples and representing the aggressor kernel.

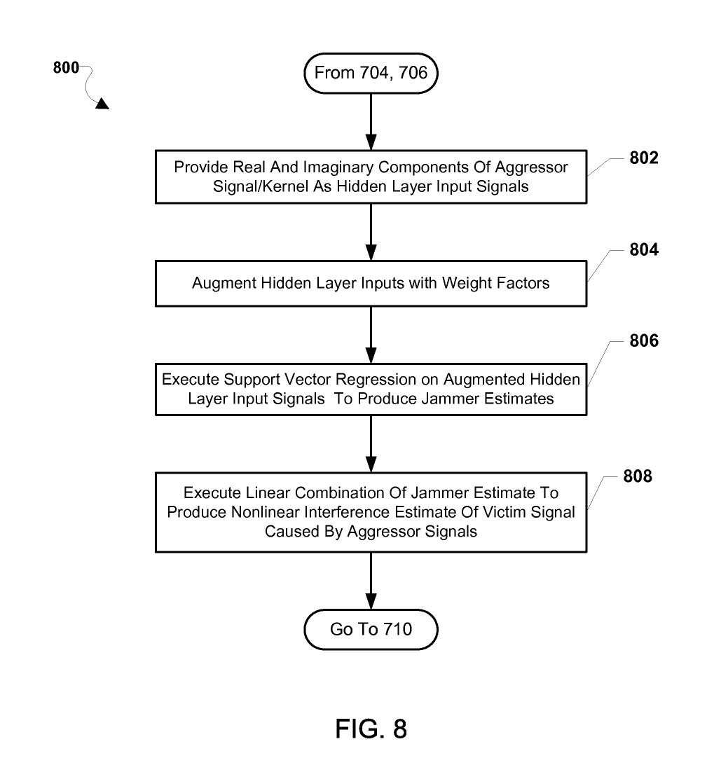

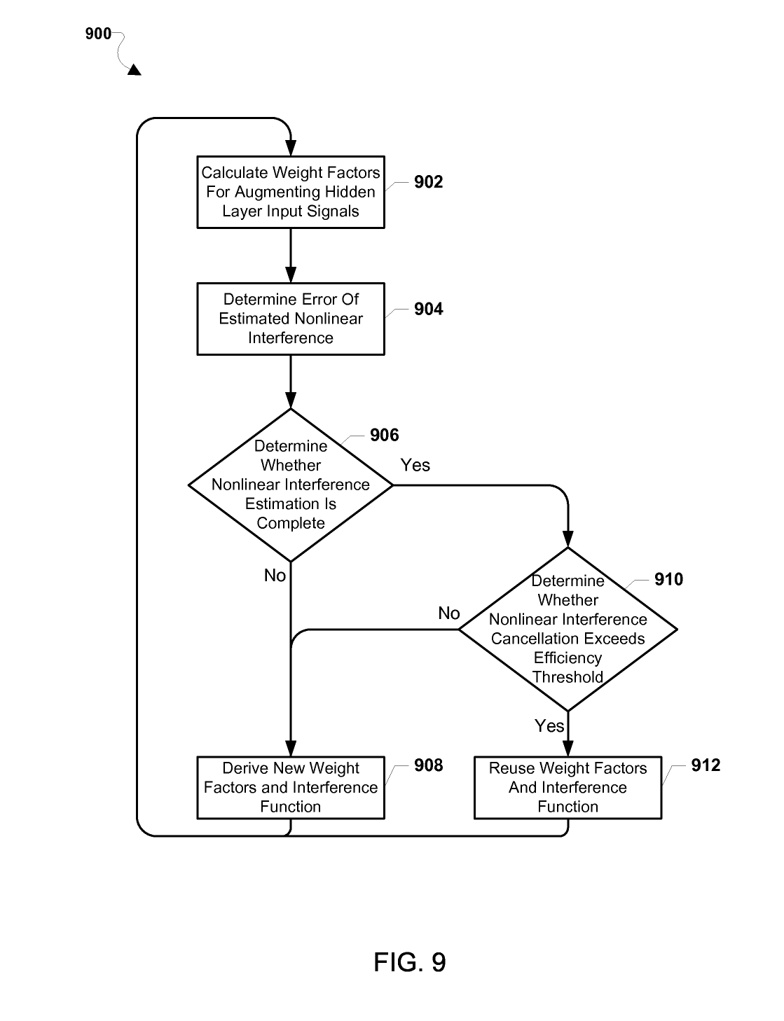

In block 708, the multi-technology communication device may estimate the nonlinear interference of the victim signal caused by the aggressor signal(s). This estimation of the nonlinear interference is discussed in further detail (e.g., with reference to FIGS. 8 and 9). In block 710, the multi-technology communication device may cancel an estimated nonlinear interference signal from the victim signal. Canceling or removing the estimated nonlinear interference from the victim signal may be implemented in a variety of known ways, such as filtration, transformation, extraction, reconstruction, and suppression. In block 712, the multi-technology communication device may decode the victim signal without presence of the interference by the aggressor signal(s). In block 714, the multi-technology communication device may advance to the next time interval “t” (e.g., move to the current time interval) and begin the process again with regard to aggressor and victim signals for the current time “t”.

FIG. 8 illustrates a method 800 for estimating a nonlinear interference signal using a support vector regression interference filter (e.g., 400 in FIG. 4) in a multi-technology wireless communications device in accordance with various embodiments. In one example, the method may be performed by a processor of the multi-technology communication device. With reference to FIGS. 1-8, the method 800 may be executed in a computing device (e.g., 110, 120, 200) using software, general purpose or dedicated hardware, or a combination of software and hardware, such as the general purpose processor 206, baseband processor 216, or the like. The method 800 may be included in method 700 in FIG. 7 as part of block 708. As described above, the victim signal and the aggressor signal or aggressor kernel may be used by the multi-technology communication device as input signals for the support vector regression interference filter. The victim signal and the aggressor signal or aggressor kernel may be received by the input layer of the support vector regression interference filter. The aggressor signal or aggressor kernel may be divided into one or more real and imaginary components. The real and imaginary components of the aggressor signal or aggressor kernel may be used as hidden layer input signals and may be manipulated in the estimation of the estimated nonlinear interference.

In block 802, the multi-technology communication device may provide the real and imaginary components of the aggressor signal or the aggressor kernel as hidden layer input signals to the hidden layer of the support vector regression interference filter. The aggressor signals may be used to generate “K” aggressor kernels in the input layer. The aggressor kernels may be passed as real and imaginary aggressor kernel components to the hidden layer. Thus, the real and imaginary aggressor kernel components may be the hidden layer inputs.

In block 804, the multi-technology communication device may augment the hidden layer input signals with weight factors. As described above, in various embodiments, the weight factors may be determined during support vector regression training, and may be re-assigned as described with reference to FIG. 9.

In block 806, the multi-technology communication device may execute a regression function derived using support vector regression algorithms on the hidden layer input signals to produce jammer signal estimates. In some embodiments, the weight factor augmentation in block 804 may occur as part of the regression function execution. In some embodiments, the augmentation and regression function may be executed through mathematical and/or logical operations. The operations implementing the augmentation may result in a multiplication of one or more weight factors with a respective hidden layer input signal elements. The operations implementing the regression function may result in the summation of the weight factors, multiplication with the hidden layer input signals and addition with a constant.

In optional block 808, the multi-technology communication device may linearly combine the real and imaginary components of the jammer signal estimate. The linear combination of the real and imaginary components of the jammer signal estimate may be linearly combined to produce an estimated nonlinear interference. In other embodiments, an estimated real nonlinear interference component may be the real components of the jammer signal estimate, and the estimated imaginary nonlinear interference component may be the imaginary components of the jammer signal estimate. The estimated real and imaginary nonlinear interference components may be combined at a later linear combine to create an estimated nonlinear interference signal.

FIG. 9 illustrates a method 900 for training weight factors for use in a support vector regression interference filter (e.g., 400 in FIG. 4) in a multi-technology wireless communications device in accordance with various embodiments. With reference to FIGS. 1-9, the method 900 may be executed in a computing device (e.g., 110, 120, 200) using software, general purpose or dedicated hardware, or a combination of software and hardware, such as the general purpose processor 206, baseband processor 216, or the like. In block 902, the multi-technology communication device may select the weight factors for augmenting the hidden layer input signals (e.g., aggressor signals or aggressor kernels). As described, in various embodiments, the weight factors may be preprogrammed during support vector regression model training. The weight factors may be selected from a range of values configured to reduce the error of the estimated nonlinear interference.

The support vector machine based regression models may have an initial or training phase and an active phase. In a training phase, a sample set of actual received reference signals may be divided into subsamples and used to execute a series of support vector regression equations according to defined constraints. During the training phase weight factors \vec{a}“” and “\vec{a}⁺” may be minimized with respect to slack variables “εᵢ” and “εᵢ⁺” and the constant “b.” A cost parameter “c” may control the cost associated with use of the slack variables and a parameter “ε” may control the precision of optimization. The dual problem may be solved to produce optimized weight factors and the regression function discussed above. The dual problem may be expressed in terms of the functions:

minₐₐ+½(α−α⁺)^{T}Q(α−α⁺)+εΣᵢ₌₁^{N}(αᵢ+αᵢ⁺)+Σᵢ₌₁^{N}yᵢ(αᵢ+αᵢ⁺) [Eq. 8]

s.t.Σᵢ₌₁^{N}(αᵢ−αᵢ⁺)=0,0≦αᵢ,αᵢ⁺≦c [Eq.9]

Q_{i,j}=K(z_{Train,i},z_{Train,j}) [Eq. 10]

where α is a set of initial weight factors, α⁺ is set of trained weight factors, ε is a slack parameter, yᵢ is a victim signal of the i-th sample set, Qᵢⱼ is a an aggressor kernel, and z_{Train,i} is a training aggressor signal. In some embodiments, the received and transmitted signals may be presumed to be zero mean, and the constant “b” may be set to zero for purposes of calculation simplification.

In some embodiments, various parameters may be fixed. For example, the cost parameter “c” may be fixed to 1, the flack variables “ε” may be fixed to 3, and the “γ” parameter of the kernel function may be fixed to 0.5. In some embodiments, the various parameters may be recalculated and optimized. Signal samples may be divided into subsamples and a grid search performed to determine optimal values for parameters c, ε, and γ.

In block 904, the multi-technology communication device may determine an error present in the estimate of the nonlinear interference. Various known methods for determining the error of a function may be used to determine the error in block 904. In some embodiments, the error calculation may be for the mean square error of the estimated nonlinear interference compared with the nonlinear interference signal caused by the aggressor signal(s).

In determination block 906, the multi-technology communication device may determine whether the estimation of the nonlinear interference is complete. Estimation of the nonlinear interference may be considered to be complete at such time as the support vector regression interference filter has finished execution and an estimated nonlinear interference signal has been obtained (i.e., the real and imaginary estimated nonlinear interference have been combined). In response to determining that the estimation of the nonlinear interference is incomplete (i.e., determination block 906=“No”), the multi-technology communication device may train the weight factors in block 908. In various embodiments, the weight factors may be trained using a support vector regression algorithm, for example gradient descent, the Gauss-Newton algorithm, and the Levenberg-Marquardt algorithm. Training of the weight factors may be regressively executed to further reduce the error of the estimated nonlinear interference. Weight factors for each node of each layer of the support vector regression interference filter may be trained. Each weight factor may depend on support vector regression training using a sample set of actual reference signals

In response to determining that the estimation of the nonlinear interference is complete (i.e., determination block 906=“Yes”), the multi-technology communication device may determine whether the nonlinear interference cancellation exceeds an efficiency threshold in determination block 910. The determination of whether the nonlinear interference cancellation exceeds the efficiency threshold may be a measure of whether the nonlinear interference is cancelled sufficiently to enable the multi-technology communication device to decode and use the victim signal. The efficiency threshold may be a precalculated or predetermined value based on historical observations of a level of accuracy present in an estimated nonlinear interference signal that is necessary to enable proper decoding of a victim signal. In some embodiments, the efficiency threshold may be based on the error value determination of the nonlinear interference in block 904, in which the error level may be compared to an acceptable error level. In some embodiments, the efficiency threshold may be based on a success rate for decoding and using the victim signal. In response to determining that the nonlinear interference cancellation does not exceed the efficiency threshold (i.e., determination block 910=“No”), the multi-technology communication device may continue to train the weight factors in block 908. Training the weight factors may reduce the amount of error in the estimated nonlinear interference so that the cancellation of the estimated nonlinear interference may result in greater success of decoding and using the victim signal.

In response to determining that the nonlinear interference cancellation does exceed the efficiency threshold (i.e., determination block 910=“Yes”), the multi-technology communication device may reuse the weight factors for subsequent estimation and cancellation of nonlinear interference in block 912. As described, the multi-technology communication device may not always train the weight factors when estimating the nonlinear interference. The nonlinear interference caused by the one or more aggressor signals may vary by different amounts under various conditions. In some embodiments, the variation in the nonlinear interference may be small enough that the previously trained weight factors may result in a sufficiently accurate estimated nonlinear interference that further training is unnecessary. Determining when to train the weight factors or reuse the weight factors may be based on one or more criteria, including time, measurements of the aggressor signal(s), victim signal quality, and nonlinear interference noise cancellation efficiency, for example including error of the estimated nonlinear interference and/or success of decoding and using the victim signal.

In some embodiments, the method 900 may be executed at various times before, during, or after the execution of the method 700 and the method 800. For example, the method 900 may be executed to calculate at least some of the weight factors before they are used to augment the hidden layer input signals in blocks 804. In some embodiments, certain blocks of the method 900 the method may not execute contiguously, but may instead execute interspersed with the blocks of the methods 700, 800.

In other words, the methods may manage interference, such as signal interference (e.g., non-linear interference), that is received in a multi-technology communication device. Managing or analyzing interference may include filtering a received aggressor signal using a support vector regression interference filter, or filtering construct. The support vector regression interference filter may include a number of layers (input layer, hidden layer, output layer, etc.), in which different mathematical operations are executed, thereby extracting a numerical representation of estimated interference from the received aggressor signal. The multi-technology communication device may receive an aggressor signal (i.e., a signal interfering with or impeding another received signal) at an input layer of the support vector regression interference filter. The multi-technology communication device may generate one or more aggressor kernels in which the sets of kernels may contain both real and imaginary elements or components (i.e., elements represented by real numbers and elements represented by imaginary numbers). The multi-technology communication device may augment the one or more aggressor kernels with weight factors (weights, weighting components) at the hidden layer of the support vector regression interference filter to produce augmented or combined hidden layer outputs. Augmentation may include multiplying each result of the radial basis function execution by a corresponding weight element (i.e., a multiplier). The multi-technology communication device may execute a first regression function (e.g. a filter function, least squares function, etc.) on the augmented hidden layer outputs at an output layer of the support vector regression interference filter to obtain a real jammer signal estimate. The multi-technology communication device may execute a second regression function (e.g., a filter function, least squares function, etc.) on the augmented hidden layer outputs at an output layer of the support vector regression interference filter to obtain an imaginary jammer signal estimate. A result of the filtering/extracting may be an estimated interference (estimated nonlinear interference, estimated interference signal), which may be subtracted from the received victim signal (i.e., the signal subject to interference by the aggressor signal) to produce a mathematical representation of the intended received signal.

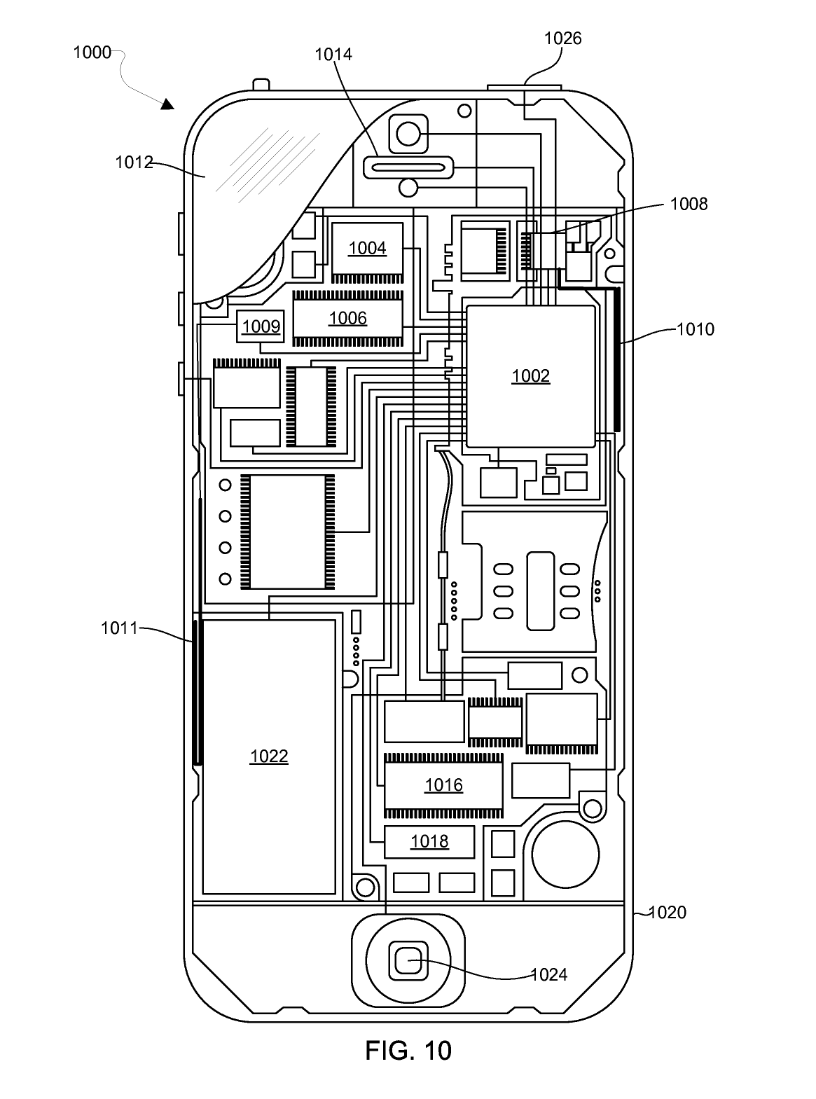

FIG. 10 illustrates an exemplary multi-technology communication device 1000 suitable for use with the various embodiments. The multi-technology communication device 1000 may be similar to the multi-technology device 110, 120, 200 (e.g., FIGS. 1 and 2). With reference to FIGS. 1-10, the multi-technology communication device 1000 may include a processor 1002 coupled to a touchscreen controller 1004 and an internal memory 1006. The processor 1002 may be one or more multicore integrated circuits designated for general or specific processing tasks. The internal memory 1006 may be volatile or non-volatile memory, and may be secure and/or encrypted memory, or unsecure and/or unencrypted memory, or any combination thereof. The touchscreen controller 1004 and the processor 1002 may also be coupled to a touchscreen panel 1012, such as a resistive-sensing touchscreen, capacitive-sensing touchscreen, infrared sensing touchscreen, etc. Additionally, the display of the multi-technology communication device 1000 need not have touch screen capability.

The multi-technology communication device 1000 may have two or more cellular network transceivers 1008, 1009 coupled to antennae 1010, 1011, for sending and receiving communications via a cellular communication network. The combination of the transceiver 1008 or 1009 and the associated antenna 1010 or 1011, and associated components, is referred to herein as a radio frequency (RF) chain. The cellular network transceivers 1008, 1009 may be coupled to the processor 1002, which is configured with processor-executable instructions to perform operations of the embodiment methods described above. The cellular network transceivers 1008, 1009 and antennae 1010, 1011 may be used with the above-mentioned circuitry to implement the various wireless transmission protocol stacks and interfaces. The multi-technology communication device 1000 may include one or more cellular network wireless modem chips 1016 coupled to the processor and the cellular network transceivers 1008, 1009 and configured to enable communication via cellular communication networks.

The multi-technology communication device 1000 may include a peripheral device connection interface 1018 coupled to the processor 1002. The peripheral device connection interface 1018 may be singularly configured to accept one type of connection, or may be configured to accept various types of physical and communication connections, common or proprietary, such as USB, FireWire, Thunderbolt, or PCIe. The peripheral device connection interface 1018 may also be coupled to a similarly configured peripheral device connection port (not shown).

The multi-technology communication device 1000 may also include speakers 1014 for providing audio outputs. The multi-technology communication device 1000 may also include a housing 1020, constructed of a plastic, metal, or a combination of materials, for containing all or some of the components discussed herein. The multi-technology communication device 1000 may include a power source 1022 coupled to the processor 1002, such as a disposable or rechargeable battery. The rechargeable battery may also be coupled to the peripheral device connection port to receive a charging current from a source external to the multi-technology communication device 1000. The multi-technology communication device 1000 may also include a physical button 1024 for receiving user inputs. The multi-technology communication device 1000 may also include a power button 1026 for turning the multi-technology communication device 1000 on and off.

The foregoing method descriptions and the process flow diagrams are provided merely as illustrative examples and are not intended to require or imply that the operations of the various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present claims.

The hardware used to implement the various illustrative logics, logical blocks, modules, and circuits described in connection with the various embodiments may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more exemplary embodiments, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed embodiments is provided to enable any person skilled in the art to make or use the present claims. Various modifications to these embodiments will be readily apparent to those skilled in the art, and the generic principles defined herein may be applied to other embodiments. Thus, the present invention is not intended to be limited to the embodiments shown herein but is to be accorded the widest scope consistent with the following claims and the principles and novel features disclosed herein.

What is claimed is:

1. A method for managing interference in a multi-technology communication device, comprising:
receiving an aggressor signal at the multi-technology communication device;
generating from the aggressor signal one or more aggressor kernels;
augmenting the one or more aggressor kernels with weight factors at a hidden layer of a support vector regression interference filter to obtain one or more augmented aggressor kernels; and
executing a first regression function on the one or more augmented aggressor kernels at the hidden layer to produce a real jammer signal estimate and executing a second regression function on the one or more augmented aggressor kernels to produce an imaginary jammer signal estimate.

2. The method of claim 1, further comprising:
executing at an output layer, a linear combination on the real jammer signal estimate and the imaginary jammer signal estimate to produce an estimated nonlinear interference.

3. The method of claim 2, further comprising:
cancelling the estimated nonlinear interference from a victim signal.

4. The method of claim 1, further comprising:
combining the real jammer signal estimate and the imaginary jammer signal estimate to produce an estimated nonlinear interference;
determining an error of the estimated nonlinear interference;
determining whether the error of the estimated nonlinear interference exceeds an efficiency threshold; and
cancelling the estimated nonlinear interference from a victim signal.

5. The method of claim 4, wherein cancelling the estimated nonlinear interference from the victim signal comprises cancelling the estimated nonlinear interference from the victim signal in response to determining that the error of the estimated nonlinear interference does not exceed the efficiency threshold,
the method further comprising training the weight factors to reduce the error of the estimated nonlinear interference in response to determining that the error of the estimated nonlinear interference exceeds the efficiency threshold.

6. The method of claim 5, wherein training the weight factors to reduce the error of the estimated nonlinear interference comprises executing a support vector regression algorithm on a set of actual received aggressor and victim signals to produce new weight factor values.

7. The method of claim 1, further comprising:
receiving one or more aggressor signal at the multi-technology communication device; and
executing a support vector regression algorithm on the one or more aggressor signals to derive the first regression function, the second regression function, and the weight factors.

8. The method of claim 1, wherein generating from the aggressor signal, the one or more aggressor kernels comprises executing a Gaussian radial basis function on the aggressor signal.

9. The method of claim 1, wherein the one or more aggressor kernels are non-inputs derived from the aggressor signal.

10. The method of claim 1, wherein the first regression function and the second regression function are equivalent models, and are associated with different weight factors.

11. A multi-technology communication device, comprising:
an antenna;
one or more processors or processor cores configured with processor-executable instructions to perform operations comprising:
receiving an aggressor signal at the multi-technology communication device;
generating one or more aggressor kernels from the aggressor signal;
augmenting the one or more aggressor kernels with weight factors at a hidden layer of a support vector regression interference filter to obtain one or more augmented aggressor kernels; and
executing a first regression function on the one or more augmented aggressor kernels at the hidden layer to produce a real jammer signal estimate and a second regression function on the one or more augmented aggressor kernels to produce an imaginary jammer signal estimate.

12. The multi-technology communication device of claim 11, wherein the one or more processors or processor cores is further configured with processor-executable instructions to perform operations comprising: executing at an output layer, a linear combination on the real jammer signal estimate and the imaginary jammer signal estimates to produce an estimated nonlinear interference.

13. The multi-technology communication device of claim 12, wherein the one or more processors or processor cores is further configured with processor-executable instructions to perform operations comprising cancelling the estimated nonlinear interference from a victim signal.

14. The multi-technology communication device of claim 11, wherein the one or more processors or processor cores are further configured with processor-executable instructions to perform operations comprising:
combining the real jammer signal estimate and the imaginary jammer signal estimate to produce an estimated nonlinear interference;
determining an error of the estimated nonlinear interference;
determining whether the error of the estimated nonlinear interference exceeds an efficiency threshold; and
cancelling the estimated nonlinear interference from a victim signal.

15. The multi-technology communication device of claim 14, wherein the one or more processors or processor cores are further configured with processor-executable instructions to perform operations comprising:
cancelling the estimated nonlinear interference from the victim signal by cancelling the estimated nonlinear interference from the victim signal in response to determining that the error of the estimated nonlinear interference does not exceed the efficiency threshold; and
training the weight factors to reduce the error of the estimated nonlinear interference in response to determining that the error of the estimated nonlinear interference exceeds the efficiency threshold.

16. The multi-technology communication device of claim 15, wherein the one or more processors or processor cores is further configured with processor-executable instructions to perform operations such that training the weight factors to reduce the error of the estimated nonlinear interference comprises executing a support vector regression algorithm on a set of actual received aggressor and victim signals to produce new weight factor values.

17. The multi-technology communication device of claim 11, wherein the one or more processors or processor cores are further configured with processor-executable instructions to perform operations comprising:
receiving one or more aggressor signals at the multi-technology communication device; and
executing a support vector regression algorithm on the one or more aggressor signals to derive the first regression function, the second regression function, and the weight factors.

18. The multi-technology communication device of claim 11, wherein the one or more processors or processor core is further configured with processor-executable instructions to perform operations such that generating from the aggressor signal, the one or more aggressor kernels further comprises executing a Gaussian radial basis function on the aggressor signal.

19. The multi-technology communication device of claim 11, wherein the one or more aggressor kernels are non-inputs derived from the aggressor signal.

20. The multi-technology communication device of claim 11, wherein the first regression function and the second regression function are equivalent models, and are associated with different weight factors.

21. A non-transitory processor-readable medium having stored thereon processor-executable software instructions to cause a processor of a multi-technology communication device to perform operations comprising:
receiving an aggressor signal at the multi-technology communication device;
generating one or more aggressor kernels from the aggressor signal;
augmenting the one or more aggressor kernels with weight factors at a hidden layer of a support vector regression interference filter to obtain one or more augmented aggressor kernels; and
executing a first regression function on the one or more augmented aggressor kernels at the hidden layer to produce a real jammer signal estimate and a second regression function on the one or more augmented aggressor kernels to produce an imaginary jammer signal estimate.

22. The non-transitory processor-readable medium of claim 21, wherein the stored processor-executable software instructions are configured to cause a processor of a multi-technology communication device to perform operations further comprising executing at an output layer, a linear combination on the real jammer signal estimate and the imaginary jammer signal estimate to produce an estimated nonlinear interference.

23. The non-transitory processor-readable medium of claim 22, wherein the stored processor-executable software instructions are configured to cause a processor of a multi-technology communication device to perform operations further comprising:
cancelling the estimated nonlinear interference from a victim signal.

24. The non-transitory processor-readable medium of claim 21, wherein the stored processor-executable software instructions are configured to cause a processor of a multi-technology communication device to perform operations further comprising:
combining the real jammer signal estimate and the imaginary jammer signal estimate to produce an estimated nonlinear interference;
determining an error of the estimated nonlinear interference;
determining whether the error of the estimated nonlinear interference exceeds an efficiency threshold; and
cancelling the estimated nonlinear interference from a victim signal.

25. The non-transitory processor-readable medium of claim 24, wherein the stored processor-executable software instructions are configured to cause a processor of a multi-technology communication device to perform operations such that cancelling the estimated nonlinear interference from the victim signal comprises cancelling the estimated nonlinear interference from the victim signal in response to determining that the error of the estimated nonlinear interference does not exceed the efficiency threshold,
wherein the stored processor-executable software instructions are configured to cause a processor of a multi-technology communication device to perform operations further comprising training the weight factors to reduce the error of the estimated nonlinear interference in response to determining that the error of the estimated nonlinear interference exceeds the efficiency threshold.

26. The non-transitory processor-readable medium of claim 25, wherein the stored processor-executable software instructions are configured to cause a processor of a multi-technology communication device to perform operations further such that training the weight factors to reduce the error of the estimated nonlinear interference comprises executing a support vector regression algorithm on a set of actual received aggressor and actual victim signals to produce new weight factor values.

27. The non-transitory processor-readable medium of claim 21, wherein the stored processor-executable software instructions are configured to cause a processor of a multi-technology communication device to perform operations further comprising:
receiving one or more aggressor signals at the multi-technology communication device; and
executing a support vector regression algorithm on the one or more aggressor signals to derive the first regression function, the second regression function, and the weight factors.

28. The non-transitory processor-readable medium of claim 21, wherein the stored processor-executable software instructions are configured to cause a processor of a multi-technology communication device to perform operations such that the one or more aggressor kernels are non-inputs derived from the aggressor signal.

29. The non-transitory processor-readable medium of claim 21, wherein the first regression function and the second regression function are equivalent models, and are associated with different weight factors.

30. A multi-technology communication device, comprising:
means for receiving an aggressor signal at the multi-technology communication device;
means for generating one or more aggressor kernels from the aggressor signal;
means for augmenting the one or more aggressor kernels with weight factors at a hidden layer of a support vector regression interference filter to obtain one or more augmented aggressor kernels; and
means for executing a first regression function on the one or more augmented aggressor kernels at the hidden layer to produce a real jammer signal estimate and a second regression function on the one or more augmented aggressor kernels to produce an imaginary jammer signal estimate.
